(19) United States
(12) Patent Application Publication
(10) Pub. No.: US 2011/0052044 A1
(43) Pub. Date: Mar. 3, 2011

(54) METHOD AND APPARATUS FOR CROSS-SECTION PROCESSING AND OBSERVATION

(76) Inventors: Haruo Takahashi, Chiba-shi (JP); Masahiro Kiyohara, Chiba-shi (JP); Makoto Sato, Chiba-shi (JP); Junichi Tashiro, Chiba-shi (JP)

(21) Appl. No.: 12/873,886

(22) Filed: Sep. 1, 2010

(30) Foreign Application Priority Data
Sep. 3, 2009 (JP) 2009-204009

(51) Int. Cl. G06T 7/00

(52) U.S. Cl. 382/154

(57) ABSTRACT

A cross-section processing and observation method includes: forming a cross section in a sample by a focused ion beam through etching processing; obtaining a cross-section observation image through cross-section observation by the focused ion beam; and forming a new cross section by performing etching processing in a region including the cross section and obtaining a cross-section observation image of the new cross section. A surface observation image of a region including a mark on the sample and the cross section is obtained. A position of the mark is recognized in the surface observation image and etching processing is performed on the cross section by setting, in reference to the position of the mark, a focused ion beam irradiation region in which to form the new cross section. Cross-section processing and observation is thus enabled continuously and efficiently using a focused ion beam apparatus having no SEM apparatus.

### RELATED APPLICATIONS

This application claims priority under 35 U.S.C. §119 to Japanese Patent Application No. 2009-204009 filed on Sep. 3, 2009, the entire content of which is hereby incorporated by reference.

### BACKGROUND OF THE INVENTION

1. Field of the Invention

The present invention relates to cross-section processing and observation of a sample using a focused ion beam apparatus.

2. Description of the Related Art

As a technique for cross-section processing and observation of a sample, such as a semiconductor, there is an FIB (Focused Ion Beam)-SEM (Scanning Electron Microscope) apparatus. The FIB-SEM apparatus performs cross-section processing on a sample by a focused ion beam and enables in-situ observation of the processed cross section by SEM without having to move the sample.

The FIB-SEM apparatus repetitively performs a step of forming a new cross section by further performing processing on the cross section observed by SEM by a focused ion beam and observing the new cross section. It thus becomes possible to reconstruct a 3D image of the sample interior from a plurality of obtained cross-section observation images. Also, because cross-section processing is proceeded by confirming the cross-section observation images, the cross-section processing can be ended when cross-section processing reaches a desired cross section. There is a processing and observation method for a defect in the sample interior using the technique described above as disclosed, for example, in JP-A-11-273613.

According to the method for sample cross-section processing and observation in the related art as described above, because the cross section processed by a focused ion beam is observed in-situ by SEM, an apparatus has to be equipped with a SEM apparatus like an FIB-SEM apparatus. However, because the FIB-SEM apparatus is an expensive apparatus having a complex configuration, there has been a need to enable observation of a processed cross section by a focused ion beam apparatus that is not equipped with a SEM apparatus.

However, in order to enable cross-section processing and observation continuously by a focused ion beam apparatus not equipped with an SEM apparatus, there are problems as follows.

That is, in order to enable cross-section observation after the processing, two steps are required: a step of tilting a sample, and a step of returning the tilt of the sample to its original degree in preparation for the next processing. In particular, in the case of minute processing, influences of positional displacement that occurs when a sample stage is moved to tilt are not negligible. In order to achieve precise processing, a processing region has to be set each time processing is performed, which results in poor work efficiency.

### SUMMARY OF THE INVENTION

The invention has an object to enable precise cross-section processing and observation continuously at high efficiency by using a focused ion beam apparatus not equipped with a SEM apparatus.

A cross-section processing and observation method according to an aspect of the invention includes: forming a cross section in a sample by a focused ion beam through etching processing; tilting the sample and obtaining a cross-section observation image through cross-section observation by the focused ion beam; returning a tilt of the sample to an original degree and forming a new cross section by performing etching processing in a region including the cross section; and tilting the sample and obtaining a cross-section observation image of the new cross section. A surface observation image is obtained by irradiating the focused ion beam on a region including a mark specifying a position on the sample and the cross section. A position of the mark is recognized in the surface observation image and etching processing is performed on the cross section in the sample by setting, in reference to the position of the mark, an irradiation region of the focused ion beam in which to form the new cross section. It thus becomes possible to set the irradiation region of the focused ion beam exactly without influences of positional displacement occurring when a sample stage is moved to tilt.

The cross-section processing and observation method may be configured in such a manner that the mark is formed through etching processing by the focused ion beam. When configured in this manner, the mark can be formed at a desired position.

Alternatively, the cross-section processing and observation method may be configured in such a manner that the mark is formed by deposition by supplying a precursor gas with the surface of the sample and irradiating the focused ion beam on the sample. When configured in this manner, the mark can be formed at a desired position.

Further, the cross-section processing and observation method may be configured in such a manner that the mark is a characteristic portion specifying a position on the sample. When configured in this manner, a step of forming the mark can be omitted.

The cross-section processing and observation method may be configured in such a manner that the irradiation region of the focused ion beam in which to form the new cross section is a region adjacent to the cross section.

The cross-section processing and observation method may be configured in such a manner that a size of the irradiation region of the focused ion beam in which to form the new cross section is same as a size of the irradiation region of the focused ion beam in which to form the cross section. When configured in this manner, cross-section observation is enabled at regular intervals.

The cross-section processing and observation method may be configured in such a manner that the irradiation region of the focused ion beam is displayed on the surface observation image as a processing frame. When configured in this manner, the operator becomes able to perform processing by confirming the irradiation region.

The cross-section processing and observation method may be configured in such a manner that a beam current of the focused ion beam used to perform the cross-section observation is switched to a beam current smaller than a beam current of the focused ion beam used to form the cross-section. When configured in this manner, a damage given by irradiation of the focused ion beam during cross-section observation can be lessened.

A cross-section processing and observation method according to another aspect of the invention includes: forming a cross section in a sample by a focused ion beam through etching processing; and tilting the sample and obtaining a cross-section observation image through cross-section observation by the focused ion beam. The sample is tilted after the cross-section observation image is obtained and a surface observation image is obtained by irradiating the focused ion beam on a region including a mark specifying a position on the sample and the cross section. A position of the mark is recognized in the surface observation image and etching processing is performed on the sample by setting, in reference to the position of the mark, an irradiation region of the focused ion beam in which to perform additional processing on the cross section. Accordingly, even when an unprocessed portion that has not been etched is found during cross-section observation, it becomes possible to set the focused ion beam irradiation region exactly to perform processing on the unprocessed portion that has not been etched by returning a sample stage to its original position.

A cross-section processing and observation apparatus according to still another aspect of the invention is a cross-section processing and observation apparatus that performs processing on a sample and includes: a focused ion beam irradiation portion; a sample stage on which to place the sample; a sample stage titling portion that tilts the sample stage; a secondary particle detection portion that detects secondary particles generated from the sample through irradiation of the focused ion beam on the sample; an observation image forming portion that forms an observation image according to a signal from the secondary particle detection portion; a display portion that displays the observation image; and an irradiation region setting portion that sets an irradiation region of the focused ion beam in reference to a position of a mark specifying a position on the observation image. It thus becomes possible to provide an apparatus capable of setting the focused ion beam irradiation region exactly without influences of positional displacement occurring when the sample stage is moved to tilt.

As has been described, according to the invention, cross-section processing and observation is enabled precisely and efficiently even by using a focused ion beam apparatus not equipped with an SEM apparatus.

### BRIEF DESCRIPTION OF THE DRAWINGS

FIG. 1 is a schematic view of a focused ion beam apparatus according to one embodiment of the invention;

FIG. 2A through FIG. 2F are sample observation images according to one embodiment of the invention;

FIG. 3A and FIG. 3B are schematic views of a sample cross section according to one embodiment of the invention; and

FIG. 4 is a flowchart according to one embodiment of the invention.

### DESCRIPTION OF THE PREFERRED EMBODIMENT

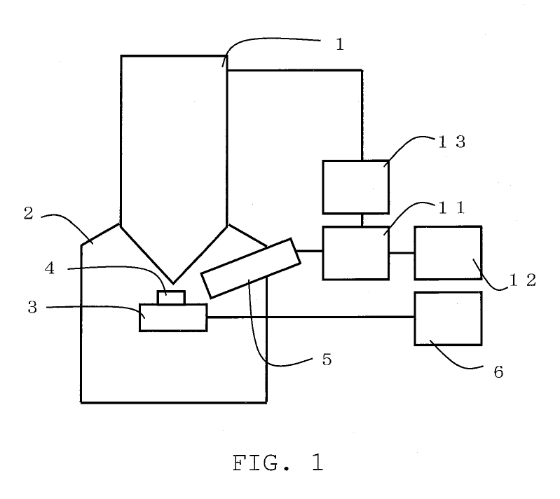

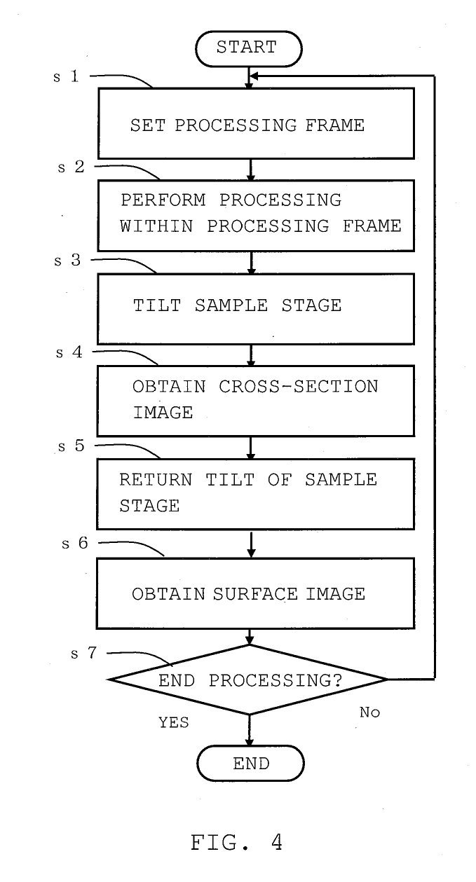

Hereinafter, one embodiment of the invention will be described on the basis of FIG. 1 through FIG. 4.

Firstly, a cross-section processing and observation apparatus according to one embodiment of the invention will be described on the basis of FIG. 1. An ion beam column 1 scans and irradiates a focused ion beam on the surface of a sample 4 placed on a sample stage 3. Secondary electrons generated from the surface of the sample 4 through irradiation of the focused ion beam are detected by a secondary electron detector 5. An observation image forming portion 11 forms an observation image according to a signal of the detected secondary electrons and a scanning signal of the focused ion beam irradiation and stores the formed observation image. A display portion 12 displays the observation image.

A sample stage tilting portion 6 tilts the sample stage 3 so that a focused ion beam from the ion beam column 1 can be irradiated on the surface and a cross section of the sample 4.

An irradiation region setting portion 13 recognizes the position of a mark specifying a position on the observation image and sets an irradiation region of a focused ion beam in reference to the recognized position. The set irradiation region of a focused ion beam is displayed on the observation image as a processing frame by the display portion 12. A cross section is then formed as the ion beam column 1 irradiates a focused ion beam on the irradiation region of a focused ion beam.

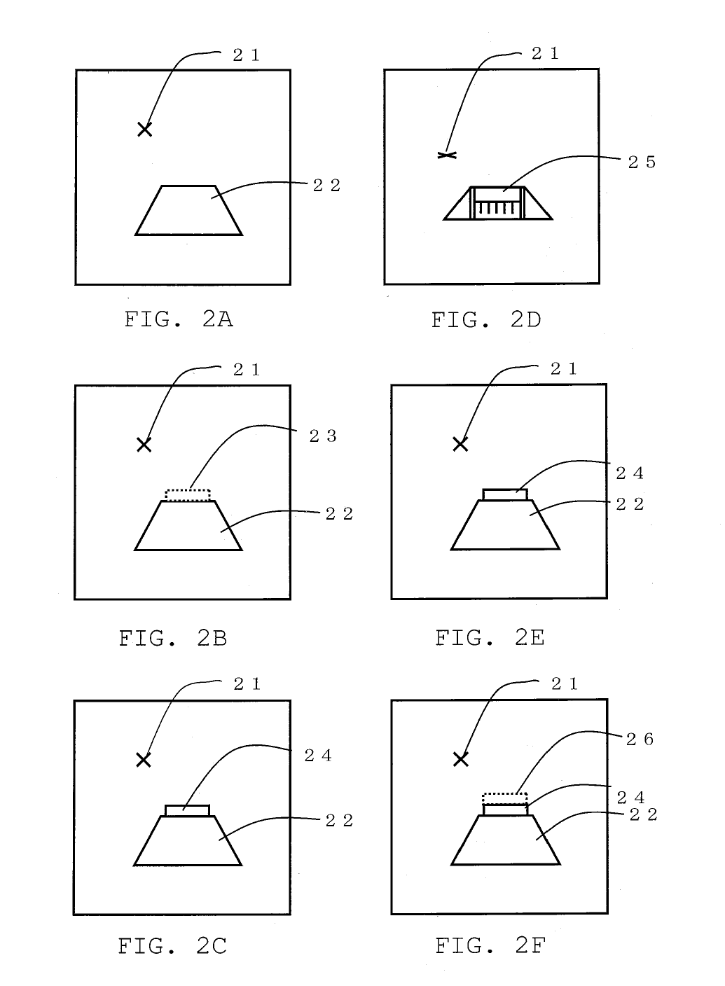

Cross-section processing and observation according to one embodiment of the invention will now be described on the basis of FIG. 2A through FIG. 4.

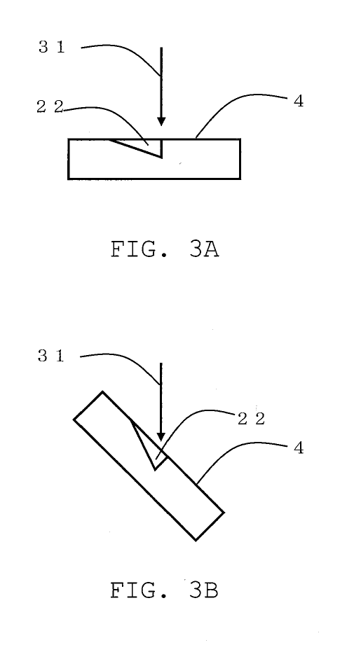

FIG. 2A through FIG. 2F are sample observation images according to one embodiment of the invention. FIG. 2A is a secondary electron (SIM) image obtained by scanning and irradiating a focused ion beam on the sample surface. A mark 21 is formed by a focused ion beam. The mark 21 may be formed through etching processing by a focused ion beam. Alternatively, local deposition formed by irradiating a focused ion beam on the sample surface while a precursor gas is supplied with the surface of the sample from a gas supply system may be used. Further, in a case where there is a characteristic portion that can be recognized in an observation image in the vicinity of a desired cross section, this characteristic portion may be used as a mark instead of forming the mark 21 by a focused ion beam. Herein, the mark 21 is of a cross shape. It should be appreciated, however, that the mark 21 is not limited to this shape. It is preferable to form the mark 21 in the vicinity of a desired cross section. An observation magnification is adjusted in advance so that the mark 21 and a desired cross section are in the same observation image. A processing hole 22 is a hole made by a focused ion beam. Cross sections are formed at a side wall of a portion corresponding to the upper side of the processing hole 22 of a trapezoidal shape. The processing hole 22 is made in this shape with the aim of collecting secondary electrons generated from the cross section efficiently into the secondary electron detector 5 by preventing the secondary electrons from colliding on the other side walls of the processing hole 22. As is shown in the schematic view of the sample cross section of FIG. 3A, the depth of the processing hole 22 varies. The processing hole 22 is deeper on the cross section side and it becomes shallower with distances from the cross section. The processing hole 22 is made in this shape with the aim of reducing a processing amount in comparison with a case where the entire processing hole 22 is made deep. It should be appreciated, however, that the processing hole 22 is not limited to this shape.

Subsequently, as is shown in FIG. 2B, a processing frame 23 in which to form a cross section is set to the processing hole 22 (s1). Etching processing is then performed by irradiating a focused ion beam to the processing frame 23 thus set (s2). Consequently, as is shown in FIG. 2C, a new processing hole 24 is formed. The sample stage 3 is tilted to observe the cross section of the new processing hole 24 thus formed (s3).

Subsequently, a cross-section image is obtained by irradiating a focused ion beam 31 to the sample cross section as is shown in FIG. 3B (s4). FIG. 2D is an observation image including a cross section 25. The interior structure of the sample 4 appears on the cross section 25. It should be noted that a beam current of a focused ion beam during observation is smaller than a beam current during formation of the new processing hole 24 through etching processing. Accordingly, cross-section observation is enabled by lessening damage given to the cross section.

Subsequently, the tilt of the sample stage 3 is returned to the original degree (s5). The positional relation of the sample 4 and the focused ion beam 31 is thus restored to the state shown in FIG. 3A. A secondary electron image is obtained by scanning and irradiating a focused ion beam on the surface of the sample 4 in this state (s6). FIG. 2E is an observation image in this instance.

Subsequently, as is shown in FIG. 2F, a new processing frame 26 is set. The setting method will be described in the following.

The position of the mark 21 is recognized from the observation image of FIG. 2E. The processing frame 26 is set adjacently to the processing frame 23 in reference to the recognized mark 21. In this instance, the size of the processing frame 26 is made the same as the size of the processing frame 23. Accordingly, cross-section observation images can be obtained at regular intervals. It thus becomes possible to precisely understand the positional relation of a plurality of obtained cross-section observation images.

By setting the processing frames as described above, an exact focused ion beam irradiation region can be set automatically even when positional displacement occurs due to tilting of the sample stage 3. The term, “positional displacement”, referred to herein means a difference in position of the new processing hole 24 within each observation image between the observation images of FIG. 2C and FIG. 2E. In particular, in a case where the processing frame is of a minute size, for example, in a case where the width of the processing frame, that is, an interval between one cross section and a new cross section, is as minute as 10 nm, influences of positional displacement occurring when the sample stage 3 is moved to tilt are not negligible.

As has been described, a step of setting a processing frame (s1), obtaining a cross-section image after cross-section processing (s4), and setting a new processing frame is performed repetitively. A plurality of cross-section images can be thus obtained. A 3D observation image can be reconstructed by combining a plurality of the obtained observation images. The processing is ended when the end of processing is determined (s7).

There is a case where an unprocessed portion remains due to insufficient etching processing during cross-section processing. In such a case, additional processing can be performed exactly on the unprocessed portion by setting the processing frame described above.

To be more concrete, an unprocessed portion is found during cross-section observation. The tilt of the sample stage 3 is returned to the original degree to obtain the surface observation image of the sample 4. The position of the mark 21 is then recognized from the obtained surface observation image. In reference to the recognized mark 21, the processing frame 23 in which the cross-section processing was performed last is displayed on the obtained surface observation image. It thus becomes possible to set the processing frame exactly on the region that needs additional processing. The additional processing on the cross section can be therefore performed precisely without influences of positional displacement occurring when the sample stage 3 is moved to tilt.

What is claimed is:

1. A cross-section processing and observation method comprising:
forming a cross section in a sample by a focused ion beam through etching processing;
tilting the sample and obtaining a cross-section observation image through cross-section observation by the focused ion beam;
returning a tilt of the sample to an original degree;
obtaining a surface observation image by irradiating the focused ion beam on a region including a mark specifying a position on the sample and the cross section;
setting an irradiation region of the focused ion beam in reference to the position of the mark;
forming a new cross section by performing etching processing in a region including the cross section; and
tilting the sample and obtaining a cross-section observation image of the new cross section.

2. The cross-section processing and observation method according to claim 1, wherein:
the mark is formed through etching processing by the focused ion beam.

3. The cross-section processing and observation method according to claim 1, wherein:
the mark is formed by deposition by supplying a precursor gas with the surface of the sample and irradiating the focused ion beam on the sample.

4. The cross-section processing and observation method according to claim 1, wherein:
the mark is a characteristic portion specifying a position on the sample.

5. The cross-section processing and observation method according to claim 1, wherein:
the irradiation region of the focused ion beam in which to form the new cross section is a region adjacent to the cross section.

6. The cross-section processing and observation method according to claim 1, wherein:
a size of the irradiation region of the focused ion beam in which to form the new cross section is same as a size of the irradiation region of the focused ion beam in which to form the cross section.

7. The cross-section processing and observation method according to claim 1, wherein:
the irradiation region of the focused ion beam is displayed on the surface observation image as a processing frame.

8. The cross-section processing and observation method according to claim 1, wherein:
a beam current of the focused ion beam used to perform the cross-section observation is switched to a beam current smaller than a beam current of the focused ion beam used to form the cross-section.

9. A cross-section processing and observation method comprising:
forming a cross section in a sample by a focused ion beam through etching processing; and
tilting the sample and obtaining a cross-section observation image through cross-section observation by the focused ion beam,
returning a tilt of the sample to an original degree;
obtaining a surface observation image by irradiating the focused ion beam on a region including a mark specifying a position on the sample and the cross section;
setting an irradiation region of the focused ion beam in reference to the position of the mark; and
performing additional processing on the cross section.

10. A cross-section processing and observation apparatus that performs processing on a sample, comprising:
a focused ion beam irradiation portion;
a sample stage on which to place the sample;
a sample stage titling portion that tilts the sample stage;
a secondary particle detection portion that detects secondary particles generated from the sample through irradiation of the focused ion beam on the sample;
an observation image forming portion that forms an observation image according to a signal from the secondary particle detection portion;
a display portion that displays the observation image; and
an irradiation region setting portion that sets an irradiation region of the focused ion beam in reference to a position of a mark specifying a position on the observation image.
